(19) United States
(12) Patent Application Publication
(10) Pub. No.: US 2020/0146907 A1
(43) Pub. Date: May 14, 2020

(54) BRAKE

(71) Applicant: Jozef STAKNE, Smartno Ob Paki (SI)

(72) Inventor: Jozef STAKNE, Smartno Ob Paki (SI)

(21) Appl. No.: 16/631,871

(22) PCT Filed: Jun. 14, 2018
(86) PCT No.: PCT/IB2018/054200

§ 371 Date: Jan. 17, 2020

(30) Foreign Application Priority Data
Jul. 28, 2017 (SI) P-201700223

(51) Int. Cl. A61G 5/10

(52) U.S. Cl. CPC A61G 5/101; A61G 5/1018; A61G 5/1035

(57) ABSTRACT

A brake for a trolley that can brake rotation of a trolley wheel only in one direction. The brake includes a support connectable with a frame of the trolley, a first axle connected with another end of the support and peripherally provided with three indents, a pivotal first handle with a detent, wherein the first handle on the first axle can assume three positions defined by the three indents, a pin connected with the first handle and arranged parallel to the first axle, an eccentric ring with a recess, through which the pin projects, wherein the eccentric ring is pivotally mounted on the first axle and can engage with the outer periphery of the pulley wheel, a tension spring connecting the inner periphery of the eccentric ring and the pin, and a stop element projecting from the first axle, which can lean against the inner periphery of the eccentric ring. The brake enables unidirectional braking of a trolley either in forward movement or in rearward movement.

### FIELD OF INVENTION

The invention refers to a trolley wheel brake, such as a wheelchair, pushchair, etc.

### PRIOR ART

Many handbrakes are known from prior art that prevent rotation of trolley wheels, thus stabilizing the position of the trolley in a certain position. Such brakes do not enable wheel braking only in one direction. This is why brakes have been developed that enable rotation of a wheel in one direction and prevent its rotation in the opposite direction. Such brake is useful when pushing/driving a trolley uphill.

A brake of this type is known from patent U.S. Pat. No. 6,253,880. The invention relates to a brake formed of a ratchet gear. The brake is fastened to the frame of the trolley and comprises an axle, a brake wheel rotatable on the axle and provided with an internal toothing, a pin movably arranged through said axle, and a lever mechanism with a first handle that enables the brake wheel to engage with the outer circumference of the trolley wheel. The internal toothing of the brake wheel and the pin are designed in a way that the pin slides on the internal toothing when the trolley wheel rotates in one direction, while the pin locks the brake wheel when the trolley rotates in the opposite direction. The trolley can thus be driven uphill, while its rearward movement is at the same time prevented.

The brake disclosed in U.S. Pat. No. 4,887,830 functions in a similar way. The brake can assume three positions: a first position, in which rotation of the wheelchair wheel is enabled, a second position, in which rotation of the wheelchair wheel is disabled, and a third position, in which rotation of the wheelchair wheel is disabled in one direction only. The brake comprises a crank mechanism with a first handle member for shifting the brake into one of said three positions, an axle, and a brake element pivotally mounted on the axle and optionally engaging with the peripheral surface of the wheelchair wheel. The brake element is designed in a way that the radius of the braking surface increases on the periphery. The third position of the brake enables rotation of the wheelchair wheel in one direction, while the brake element engages with the wheelchair wheel when the wheel rotates in the opposite direction, thus preventing its rotation.

A drawback of known brakes is their ability to enable unidirectional braking only in direction of the movement of a trolley. In a rearward uphill movement of a trolley, for instance, unidirectional braking of the trolley with known brakes is not enabled.

### TECHNICAL PROBLEM

The technical problem is to conceive a brake that will be simple in construction, reliable, and would selectively enable unidirectional braking of a trolley wheel either in forward movement or in rearward movement.

### SOLUTION TO THE TECHNICAL PROBLEM

The technical problem is solved by the brake for a trolley that comprises:
a support connectable with its first end with a frame of the trolley,
a first axle connected with another end of the support and peripherally provided with three indents,
a first handle with a detent, said first handle being pivotally arranged on said first axle, wherein the first handle can assume three positions on the first axle, which are defined by the three indents,
a pin that is firmly connected with one of its ends with the first handle and arranged parallel to the first axle at a radial distance therefrom,
an eccentric ring with a closed bottom, in which at least an arcuate recess concentric with the first axle is formed, through which the pin projects, wherein the eccentric ring is pivotally mounted on the first axle and can engage with the outer periphery of a trolley wheel,
a tension spring connecting the inner periphery of the eccentric ring and the pin, and
a stop element projecting from the first axle, which can lean against the inner periphery of the eccentric ring thus preventing pivoting of the eccentric ring around the first axle in one direction.

Based on a selection by the user, the first handle with the detent can assume three positions: a first end position, a second end position, and a middle position located between both end positions.

In the middle position, the eccentric ring is remote from the outer periphery of the trolley wheel and the trolley wheel can freely rotate. In this position, the first handle with the detent, the tension spring, and the stop element are aligned. The tension spring forces the eccentric ring into the central position.

A shift of the first handle from the middle position to the first end position causes a shift of the eccentric ring such that the outer periphery of the eccentric ring contacts the outer periphery of the trolley wheel. While the trolley wheel rotates in one direction it pushes the eccentric ring away from the trolley wheel against the force of the tension spring, wherewith the rotation of the trolley wheel is enabled. While the trolley wheel rotates in another direction it pushes the eccentric ring against the trolley wheel for the blocking effect, wherewith the rotation of the trolley wheel is disabled. The stop element leans against the inner periphery of the eccentric ring and prevents further rotation of the eccentric ring around the first axle and consequently too excessive blocking of the eccentric ring against the trolley wheel.

When the first handle is shifted from the middle position to the second end position, the situation is similar to the above-identified one, only that unidirectional braking is here achieved in the opposite direction of the trolley wheel rotation.

The support can be firmly connected with the frame of the trolley. Such brake is suitable to be arranged on a trolley that is already provided with a conventional bidirectional brake.

In a further embodiment, the support is articulated with the frame of the trolley. In this case, the middle part of the support is articulated with the crank mechanism with the second handle which can in turn be articulated with the frame of the trolley. If the second handle is shifted, the eccentric ring can, while the first handle is in the middle position, additionally assume the position of the bidirectional braking of the trolley wheel.

An advantage of the brake of the invention over known brakes lies in its ability to enable unidirectional braking of a trolley wheel either in forward movement or in rearward movement. A further advantage is a simple construction of the brake and its reliable operation.

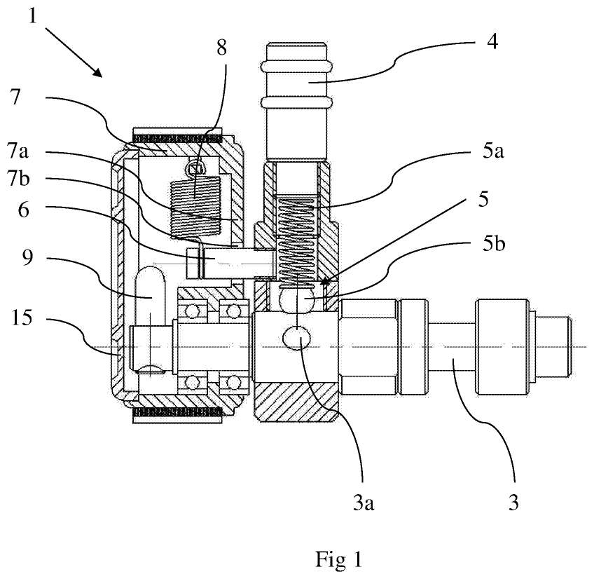

FIG. 1: Brake in cross-section

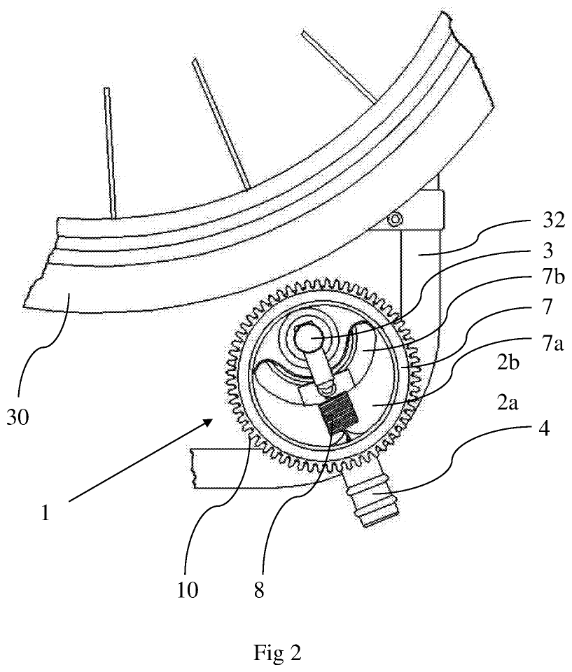

FIG. 2: Brake in side view

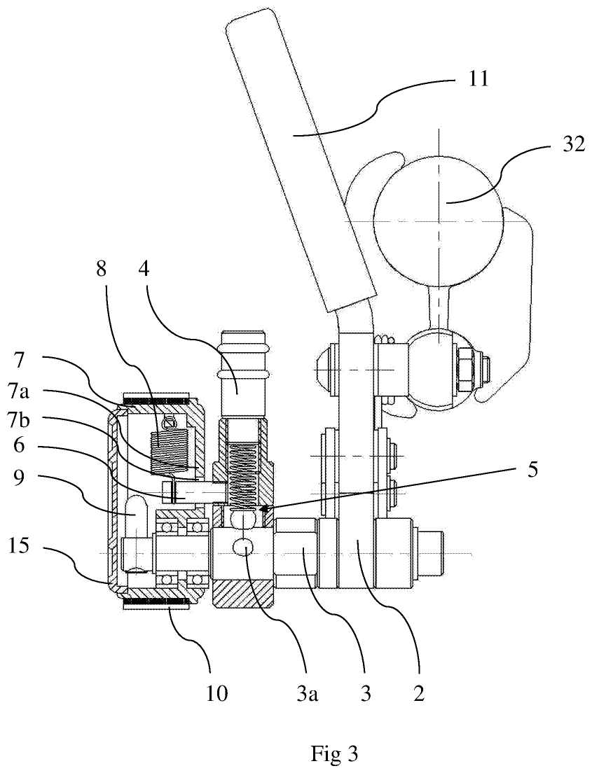

FIG. 3: Brake with a crank mechanism in cross-section

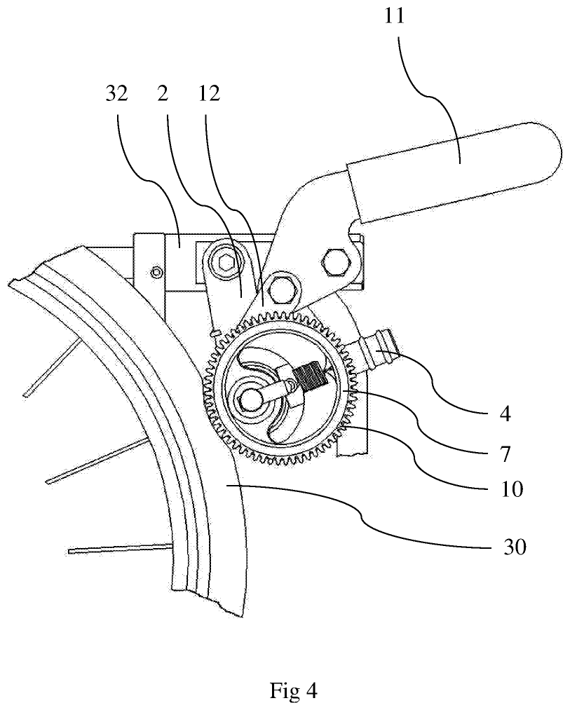

FIG. 4: Brake with a crank mechanism in side view

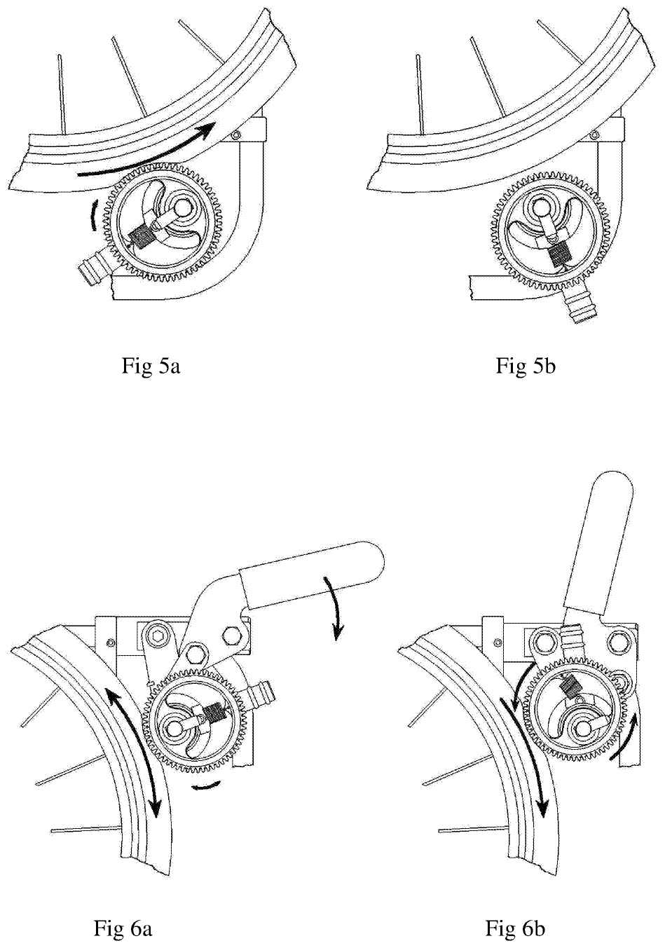

FIG. 5a: Brake in a position of unidirectional braking

FIG. 5b: Brake in a released position

FIG. 6a: Brake with a crank mechanism in a position of bidirectional braking

FIG. 6b: Brake with a crank mechanism in a position of unidirectional braking

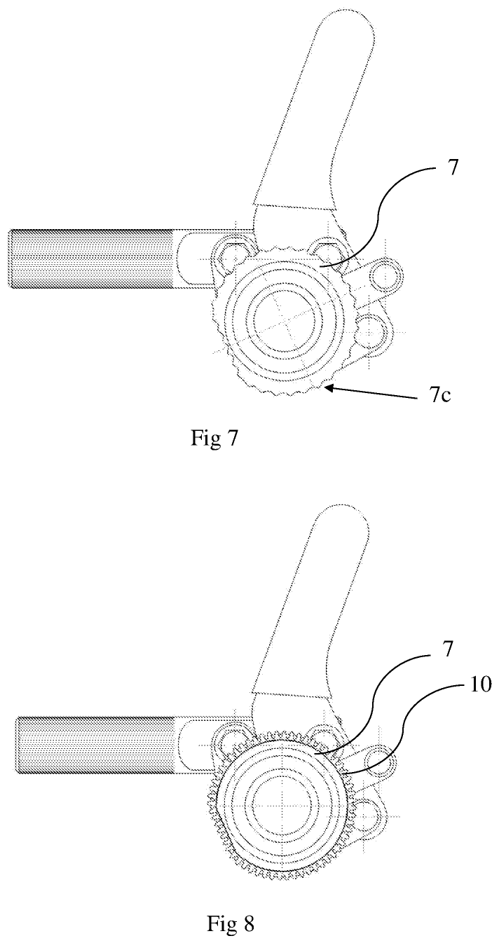

FIG. 7: Brake with an eccentric ring with a corrugated outer periphery

FIG. 8: Brake with an eccentric ring with a corrugated brake pad

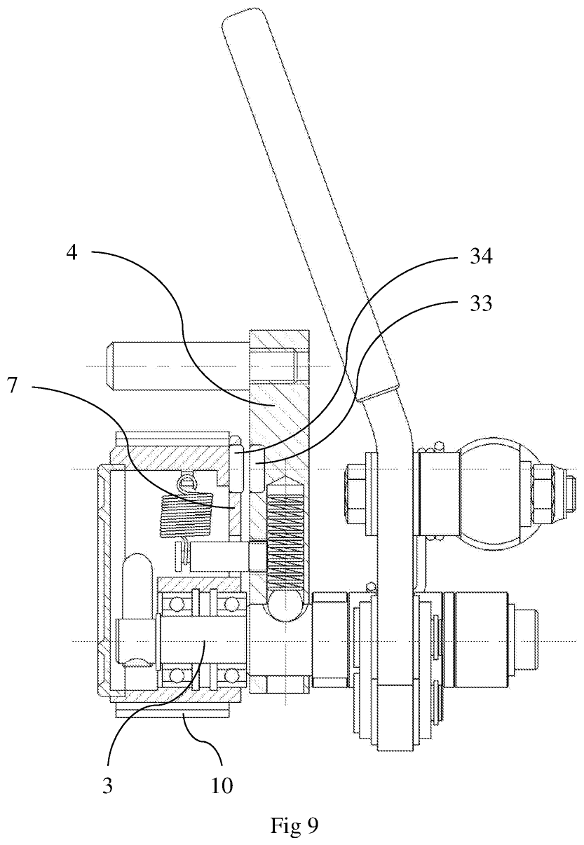

FIG. 9: Brake with two permanent magnets

The invention is described in more detail hereinbelow.

The technical problem is solved by a brake 1 for a trolley that comprises:
a support 2 connectable with its first end with a frame 32 of the trolley,
a first axle 3 connected with another end of the support and peripherally provided with three indents 3a,
a first handle 4 with a detent 5, said handle 4 being pivotally arranged on said first axle 3, and wherein the first handle 4 can assume three positions on the first axle 3, which are defined by the three indents 3a,
a pin 6 that is firmly connected with one of its ends with the first handle 4 and arranged parallel to the first axle 3 at a radial distance therefrom,
an eccentric ring 7 with a closed bottom 7a, in which at least an arcuate recess 7b concentric with the first axle is formed, through which the pin 6 projects, wherein the eccentric ring 7 is pivotally mounted on the first axle 3 and engages with the outer periphery of a trolley wheel 30,
a tension spring 8 connecting the inner periphery of the eccentric ring 7 and the pin 6, and
a stop element 9 projecting from the first axle 3, which can lean against the inner periphery of the eccentric ring 7 thus preventing rotation of the eccentric ring 7 around the first axle 3 in one direction.

Based on a selection by the user, the first handle 4 with the detent 5 can assume three positions corresponding to three indents 3a: a first end position, a second end position, and a middle position located between both end positions.

In the middle position, the eccentric ring is remote from the outer periphery 30 of the trolley wheel and the trolley wheel can freely rotate. In this position, the first handle 4 with the detent 5, the tension spring 8, and the stop element 9 are aligned. The tension spring 8 forces the eccentric ring 7 into the central position.

The detent 5 of the first handle 4 can be formed of a pressure spring 5a and a ball 5b that can engage with said three indents 3a on the first axle 3.

A shift of the first handle 4 from the middle position to the first end position causes a shift of the eccentric ring 7 such that the outer periphery of the eccentric ring contacts the outer periphery of the trolley wheel. While the trolley wheel 30 rotates in one direction it pushes the eccentric ring 7 away from the trolley wheel 30 against the force of the tension spring 8, wherewith the rotation of the trolley wheel is enabled. While the trolley wheel rotates in another direction it pushes the eccentric ring 7 against the trolley wheel 30 due to the blocking effect, wherewith the rotation of the trolley wheel is disabled. The stop element 9 leans against the inner periphery of the eccentric ring 7 and prevents further rotation of the eccentric ring around the first axle 3 and consequently too excessive blocking of the eccentric ring 7 against the trolley wheel.

When the first handle is shifted from the middle position to the second end position, the situation is similar to the above-identified one, only that unidirectional braking is here achieved in the opposite direction of the trolley wheel rotation.

The outer periphery of the eccentric ring 7 can be corrugated 7c, what improves the efficiency of braking in both dry and wet conditions. The eccentric ring 7 can further be provided on its outer periphery by a brake pad 10. The brake pad 10 can be corrugated from the outer side. The material of the brake pad 10 can be for instance glass-fiber reinforced polychloroprene.

The support 2 can be firmly connected with the frame of the trolley. Such brake is suitable to be arranged on a trolley that is already provided with a conventional bidirectional brake.

In a further embodiment, the support 2 can be articulated with the frame 32 of the trolley. In this case, the middle part of the support 2 is articulated with the crank mechanism 12 with the second handle 11 which can in turn be articulated with the frame 32 of the trolley. If the second handle is shifted, the eccentric ring 7 can, while the first handle 4 is in the middle position, additionally assume the position of the bidirectional braking of the trolley wheel 30.

The brake 1 can further comprise a cover 15, with which the eccentric ring 7 is covered.

The brake 1 can further comprise a first 33 and a second 34 permanent magnet, wherein the first permanent magnet 33 is arranged on the first handle 4 facing the eccentric ring 7, and the second permanent magnet 34 is arranged on the eccentric ring 7 opposite the first permanent magnet 33, when the first handle 4 is in its middle position. The first 33 and the second 34 permanent magnets must be oriented in a way to attract each other. It is the function of the permanent magnets to prevent oscillations of the eccentric ring 7 around the first axle 3 when the trolley moves on an uneven surface (e.g. sand); the eccentric ring 7, more precisely its brake pad 10, is herewith prevented from engaging with the outer periphery of the trolley wheel, what would cause an undesired braking of the trolley.

1. A brake for a trolley that comprises:
a support connectable with its first end with a frame of the trolley,
a first axle connected with another end of the support and peripherally provided with three indents,
a first handle with a detent, said handle being pivotally arranged on said first axle, and wherein the first handle can assume three positions on the first axle, which are defined by the three indents,
a pin that is firmly connected with one of its ends with the first handle and arranged parallel to the first axle at a radial distance therefrom,
an eccentric ring with a closed bottom, in which at least an arcuate recess concentric with the first axle is formed, through which the pin projects, wherein the eccentric ring is pivotally mounted on the first axle and can engage with the outer periphery of a trolley wheel,
a tension spring connecting the inner periphery of the eccentric ring and the pin, and
a stop element projecting from the first axle, which can lean against the inner periphery of the eccentric ring thus preventing rotation of the eccentric ring around the first axle in one direction.

2. The brake according to claim 1, wherein, based on a selection by the user, the first handle with the detent can be positioned into three positions corresponding to three indents: a first end position, a second end position, and a middle position located between both end positions.

3. The brake according to claim 1, wherein the first handle with the detent, the tension spring, and the stop element are aligned when the first handle is in the middle position.

4. The brake according to claim 1, wherein the detent of the first handle is formed of a pressure spring and a ball that can engage with said three indents on the first axle.

5. The brake according to claim 1, wherein the eccentric ring is corrugated on its outer periphery.

6. The brake according to claim 1, wherein the eccentric ring is provided with a brake pad.

7. The brake according to claim 6, wherein the brake pad is corrugated from the outer side.

8. The brake according to claim 6, wherein the brake pad is formed of glass-fiber reinforced polychloroprene.

9. The brake according to claim 1, wherein the support is firmly connectable with the frame of the trolley.

10. The brake according to claim 1, wherein the support can be articulated with the frame of the trolley.

11. The brake according to claim 10, which further comprises a crank mechanism and a second handle, wherein the middle part of the holder is articulated via the crank mechanism with the second handle which can be articulated with the frame of the trolley, such that by moving the second handle the eccentric ring can be brought into a position of bidirectional braking of the trolley wheel, when the first handle is in the middle position.

12. The brake according to claim 1, which further comprises a cover, with which the eccentric ring can be covered.

13. The brake according to claim 1, which further comprises a first and a second permanent magnet, wherein the first permanent magnet is arranged on the first handle facing the eccentric ring, and the second permanent magnet is arranged on the eccentric ring opposite the first permanent magnet, when the first handle is in its middle position, wherein the first and the second permanent magnets are oriented in a way to attract each other.
